(19) United States
(12) Patent Application Publication
(10) Pub. No.: US 2025/0097837 A1
(43) Pub. Date: Mar. 20, 2025

(54) OPTIMIZING HARQ CB FOR MULTI-CELL WITH NETWORK ENERGY SAVING

(71) Applicant: QUALCOMM Incorporated, San Diego, CA (US)

(72) Inventors: Diana MAAMARI, San Diego, CA (US); Kazuki TAKEDA, Minato-ku (JP); Ahmed Attia ABOTABL, San Diego, CA (US); Mickael MONDET, Louannec (FR); Huilin XU, Temecula, CA (US)

(21) Appl. No.: 18/470,315

(22) Filed: Sep. 19, 2023

(51) Int. Cl. H04W 52/02; H04L 1/1829; H04L 1/1867; H04L 5/00

(52) U.S. Cl. CPC H04W 52/0203; H04L 1/1861; H04L 1/1893; H04L 5/001

(57) ABSTRACT

A method for wireless communication at a user equipment (UE) and related apparatus are provided. In the method, the UE receives a set of configuration parameters related to a hybrid automatic repeat request (HARQ) acknowledgement (ACK) codebook from a network entity, and identifies an operating state for each component carrier (CC) of multiple CCs associated with the UE based on the set of configuration parameters. The UE further allocates one or more entries of the HARQ ACK codebook based on the operating state for each CC of the multiple CCs, and transmits the HARQ ACK feedback associated with the one or more entries of the HARQ ACK codebook to the network entity.

### TECHNICAL FIELD

The present disclosure relates generally to communication systems, and more particularly, to the optimization of multi-cell hybrid automatic repeat request (HARQ) codebook (CB) for network energy saving in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to receive, from a network entity, a set of configuration parameters related to a hybrid automatic repeat request (HARQ) acknowledgement (ACK) codebook; identify, based on the set of configuration parameters, an operating state for each component carrier (CC) of multiple CCs associated with the UE; allocate one or more entries of the HARQ ACK codebook based on the operating state for each CC of the multiple CCs; and transmit, to the network entity, HARQ ACK feedback associated with the one or more entries of the HARQ ACK codebook.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to transmit, for a UE, a set of configuration parameters related to a HARQ ACK codebook, where the set of configuration parameters identify an operating state for each CC of multiple CCs associated with the UE; and receive, from the UE, HARQ ACK feedback associated with the HARQ ACK codebook. One or more entries of the HARQ ACK codebook may be related to the operation state for each CC of the multiple CCs.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of dynamic DL control information (DCI) parsing for multi-cell scheduling.

FIG. 5 is a diagram illustrating an example of semi-static HARQ ACK codebook.

FIG. 6 is a diagram illustrating an example of the adaptation of the semi-static HARQ ACK codebook size in accordance with various aspects of the present disclosure.

FIG. 7 is a call flow diagram illustrating a method of wireless communication in accordance with various aspects of the present disclosure.

FIG. 8 is a flowchart illustrating methods of wireless communication at a UE in accordance with various aspects of the present disclosure.

FIG. 9 is a flowchart illustrating methods of wireless communication at a UE in accordance with various aspects of the present disclosure.

FIG. 10 is a flowchart illustrating methods of wireless communication at a network entity in accordance with various aspects of the present disclosure.

FIG. 11 is a flowchart illustrating methods of wireless communication at a network entity in accordance with various aspects of the present disclosure.

FIG. 12 is a diagram illustrating an example of a hardware implementation for an example apparatus and/or network entity.

FIG. 13 is a diagram illustrating an example of a hardware implementation for an example network entity.

### DETAILED DESCRIPTION

In wireless communication, user equipment (UE) may send hybrid automatic repeat request (HARQ) acknowledgment (ACK) feedback to the network (e.g., a base station) upon successfully receiving and decoding a data transmission. The HARQ ACK feedback ensure reliable data transmission between the network (e.g., base stations) and the UE. HARQ ACK feedback may be either semi-static (e.g., Type 1), where the structure, format, and resources used for transmitting the HARQ ACK feedback are predefined and remain constant for a certain period or the whole communication session, or dynamic (e.g., Type 2), where the structure, format, and resources used for transmitting the HARQ ACK feedback may be dynamically adapted based on the network conditions. The HARQ ACK feedback may include a predefined set of code values or sequences used to represent different HARQ ACK feedback, which may be defined in the HARQ ACK codebook (CB). When multiple component carriers (CCs) are used to communicate with the UE, the semi-static HARQ ACK codebooks for these CCs may include a large set of code values or sequences, which may lead to increased complexity and resource utilization. Additionally, current HARQ ACK feedback mechanisms often do not consider the different operating states of cells (e.g., whether a CC is in a discontinuous transmission (DTX)/discontinuous reception (DRX) active or inactive state), resulting in resource usage inefficiencies. Example aspects present herein address these issues by optimizing Type 1 HARQ-ACK CB for cell DTX. The main idea is to remove physical downlink shared channel (PDSCH) occasions during cell DTX active time from candidate PDSCH occasions in Type 1 HARQ-ACK CB.

Various aspects relate generally to wireless communication. Some aspects more specifically relate to the optimization of multi-cell HARQ codebook for network energy saving in wireless communication. In some examples, UE may receive a set of configuration parameters related to the HARQ ACK codebook from a network entity, and identify an operating state for each CC of multiple CCs associated with the UE based on the set of configuration parameters. The UE may further allocate one or more entries of the HARQ ACK codebook based on the operating state for each CC of the multiple CCs, and transmit, to the network entity, HARQ ACK feedback associated with the one or more entries of the HARQ ACK codebook.

Particular aspects of the subject matter described in this disclosure can be implemented to realize one or more of the following potential advantages. In some examples, by adapting the HARQ ACK codebooks based on active/inactive operating states of the cells, the described techniques can be used to reduce unnecessary HARQ ACK feedback for inactive cells, thereby reducing signaling overhead and improving resource efficiency. In some examples, by adjusting the codebook configurations based on the multi-cell scheduling commands, the described techniques can be used to ensure that the feedback is optimized for the set of co-scheduled cells, leading to more accurate and efficient feedback processes.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

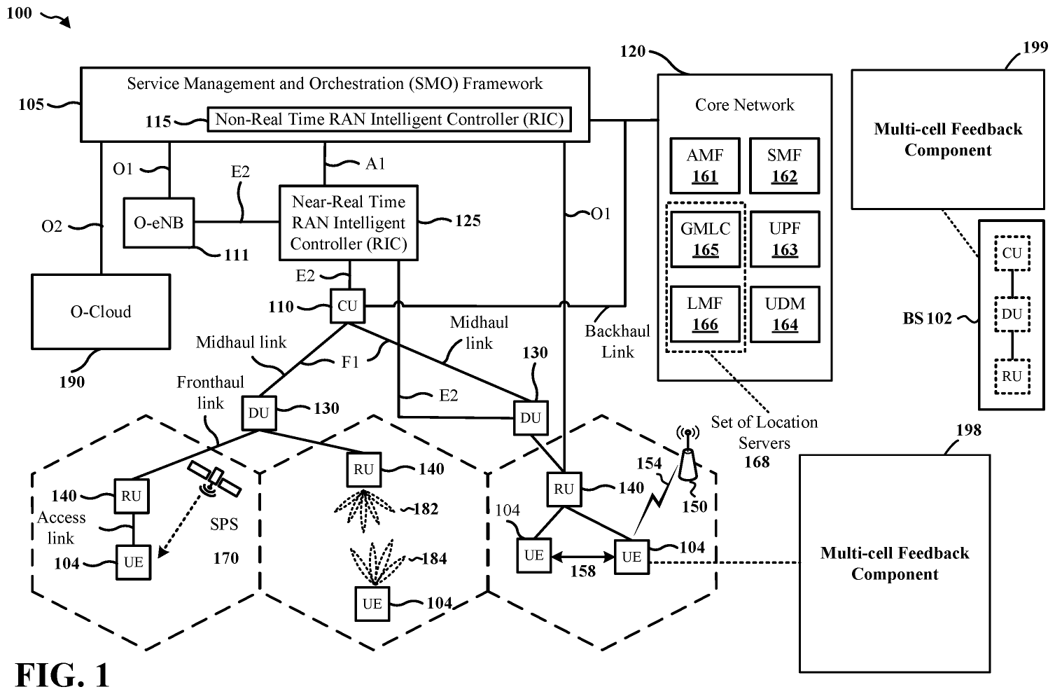

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a multi-cell feedback component 198. The multi-cell feedback component 198 may be configured to receive, from a network entity, a set of configuration parameters related to a HARQ ACK codebook; identify, based on the set of configuration parameters, an operating state for each CC of multiple CCs associated with the UE; allocate, based on the operating state for each CC of the multiple CCs, one or more entries of the HARQ ACK codebook; and transmit, to the network entity, HARQ ACK feedback associated with the one or more entries of the HARQ ACK codebook. In certain aspects, the base station 102 may include the multi-cell feedback component 199. The multi-cell feedback component 199 may be configured to transmit, for a UE, a set of configuration parameters related to a HARQ ACK codebook, where the set of configuration parameters identify an operating state for each CC of multiple CCs associated with the UE; and receive, from the UE, HARQ ACK feedback associated with the HARQ ACK codebook. One or more entries of the HARQ ACK codebook are related to the operation state for each CC of the multiple CCs. Although the following description may be focused on 5G NR, the concepts described herein may be applicable to other similar areas, such as LTE, LTE-A, CDMA, GSM, and other wireless technologies.

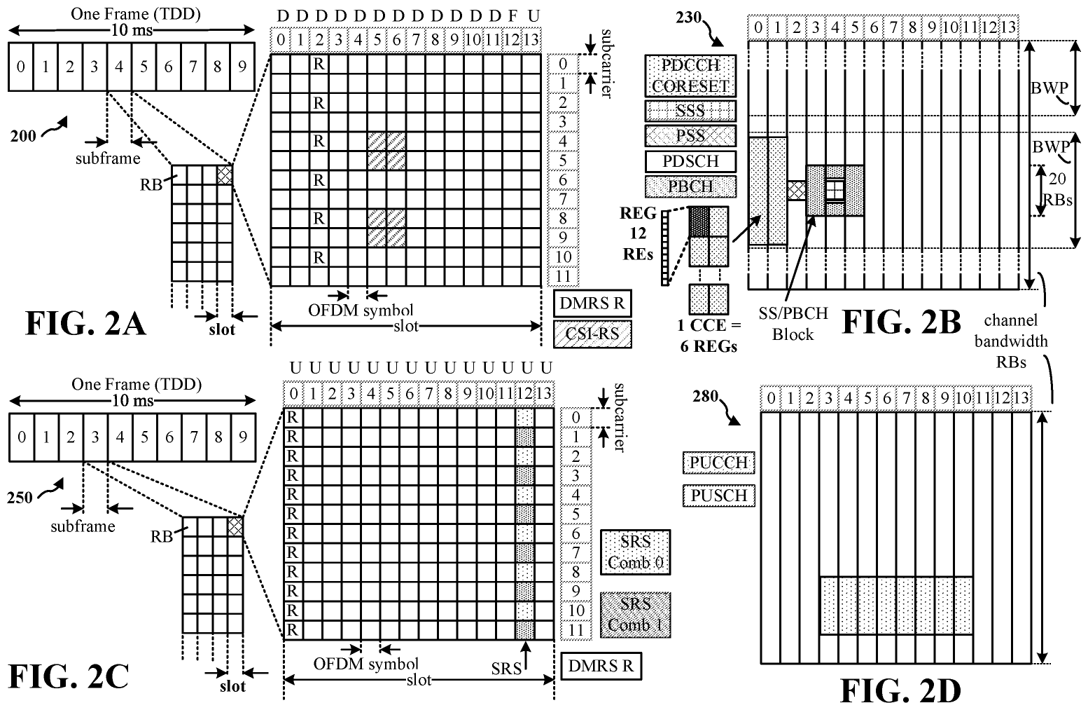

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2 slots/subframe. The subcarrier spacing may be equal to 2*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

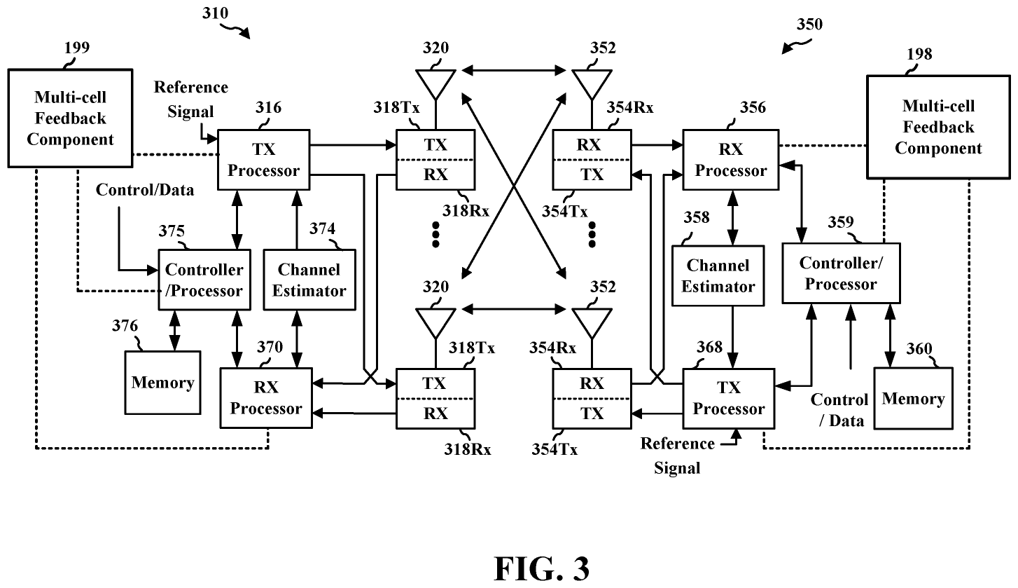

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the multi-cell feedback component 198 of FIG. 1.

At least one of the TX processor 316, the RX processor 370, and the controller/processor 375 may be configured to perform aspects in connection with the multi-cell feedback component 199 of FIG. 1.

Example aspects presented herein provide methods and apparatus for optimizing Type 1 HARQ-ACK CB for cell DTX. The main idea is to remove PDSCH occasions during cell DTX active time from candidate PDSCH occasions in Type 1 HARQ-ACK CB.

In wireless communication, a cellular network may include multiple cells, such as a primary cell (PCell) and one or more secondary cells (SCells), communicating with UE. To optimize overall network performance and mitigate inter-cell interference, the data transmission and reception across these multiple cells may be coordinated, a process referred to as multi-cell scheduling. When multi-cell scheduling is implemented, the scheduling decisions may be coordinated across the multiple cells. Hence, UE may dynamically parse the DCI received from multiple cells (e.g., multiple base stations) to determine the relevant parameters for multi-cell scheduling.

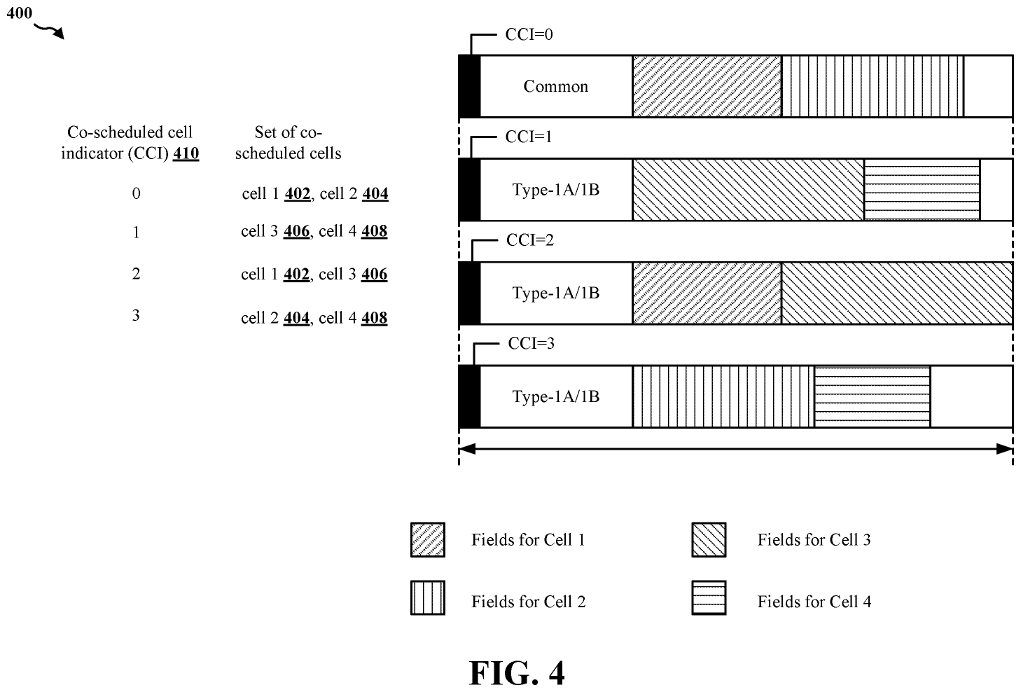

FIG. 4 is a diagram 400 illustrating an example of dynamic DCI parsing for multi-cell scheduling. In FIG. 4, a co-scheduled cell indicator (CCI) 410 may indicate a set of co-scheduled cells. For example, as shown in FIG. 4, CCI 0 may represent the co-scheduled cells of cell 1 402 and cell 2 404, CCI 1 may represent the co-scheduled cells of cell 3 406 and cell 4 408, CCI 2 may represent the co-scheduled cells of cell 1 402 and cell 3 406, and CCI 4 may represent the co-scheduled cells of cell 2 404 and cell 4 408. For PDCCH monitoring for DCI format 0_X/1_X (X=0, 1) for multi-cell PUSCH/PDSCH scheduling, the total payload may be based on the combination of cells that result in the largest payload. In the example of FIG. 4, the largest payload is associated with CCI=2 (i.e., for the co-scheduled cells of cell 1 402 and cell 3 406).

In a multi-cell scheduling scenario, the UE may receive data transmissions from multiple base stations simultaneously, and therefore may send acknowledgment (ACK) or negative acknowledgement (NACK) for each received data transmission back to the corresponding base station. The HARQ ACK codebook, which includes a set of predefined binary sequences for sending ACK/NACK transmissions, may help in coordinating the ACK/NACK transmissions from the UE to the multiple base stations. Depending on how the content of the codebook is determined, HARQ ACK codebook may be semi-static (e.g., Type 1), where the set of binary sequences used for sending the ACK/NACK is predefined and does not change during the transmission, or dynamic (e.g., Type 2), where the binary sequences used for ACK/NACK transmissions may change dynamically during the transmission based on various factors, such as the network conditions or the number of participating cells.

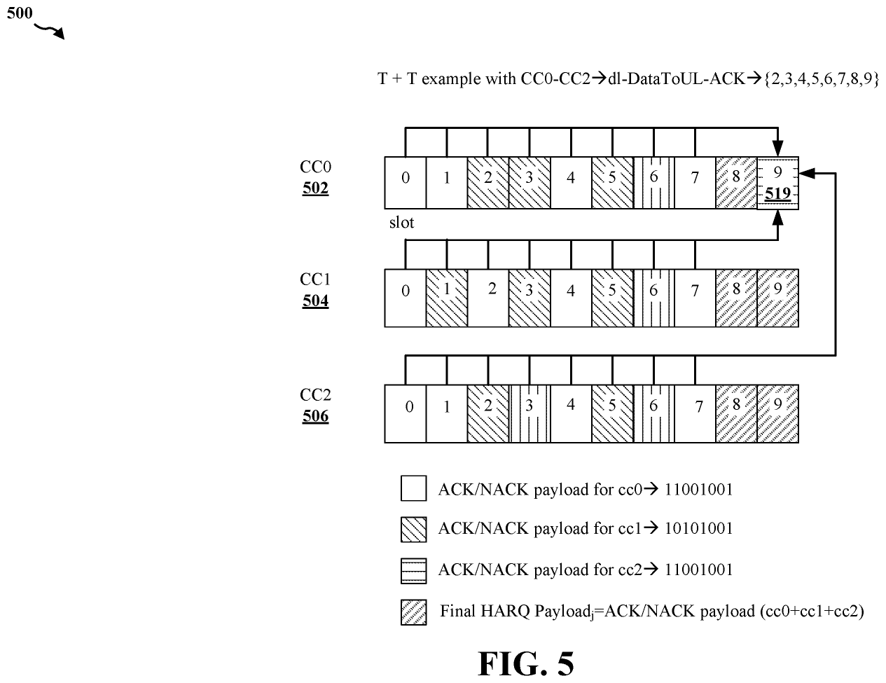

FIG. 5 is a diagram 500 illustrating an example of semi-static HARQ ACK codebook. In FIG. 5, CC0 502 may be configured with PUCCH carries ACK/NACK for all CCs (e.g., CC0 502, CC1 504, and CC2 506), and dl-DataToUL-ACK may map all HARQ ACK/NACK bits to be transmitted on, for example, slot 9 519. The ACK/NACK payload for each CC may be concatenated to get the final payload. In the example of FIG. 5, UE may generate a total of 8*3=24 HARQ ACK/NACK bits. If 2 TBs are transmitted at every PDSCH opportunity and HARQ-ACK-Spatial-bundling is not enabled, UE may generate a total of 8*2*3=48 HARQ ACK/NACK bits. If code block group (CBG) based HARQ transmission (e.g., maxCodeBlockGroupsPerTransportBlock=n4) are enabled, the payload may increase to 4*8*3=96 bits.

In wireless communication, if a semi-static HARQ ACK codebook has a large size when managing multiple component carriers (CCs), it may lead to increased complexity and resource utilization. Additionally, the HARQ ACK codebook may not consider the sleep/awake status of the cell(s), which may be determined based on the cell's discontinuous transmission (DTX)/discontinuous reception (DRX) state. As used herein, a component carrier (CC) may refer to a frequency band that is used for transmitting and receiving data.

In scenarios where cells are configured with cell DTX/DRX state, the semi-static HARQ ACK codebooks can be adapted based on the activity status of the cell (i.e., whether the cell is in an DTX/DRX active or inactive state. Adapting the HARQ ACK codebooks in this manner may bring significant advantages, including increased reliability and a reduction in payload size.

Example aspects presented herein propose a cell DTX/DRX Aware-Type 1 codebook (CB). In this approach, the transmission of HARQ ACK would occur when the corresponding component carrier (CC) is in the cell DTX/DRX active state. This ensures that the HARQ ACK feedback for a specific carrier is transmitted when necessary, thereby allowing for a reduction in codebook size and decreased resource utilization. Hence, the semi-static codebook size may become adaptive instead of fixed, and the adaptation may be based on whether the component carrier is in the DTX/DRX active state.

In some aspects, the size and content of a cell DTX/DRX aware codebook may be adjusted based on the current active component carrier. The codebook may be designed to accommodate the maximum number of active carriers while maintaining a compact size when fewer carriers are active. With the component carriers in the DTX/DRX active or inactive states, the shared codebook may be updated accordingly, and this configuration may be managed by the base station (e.g., gNB) which may manage the cells for a UE, including the PCell/PSCell and SCells. For example, if the DTX/DRX state of one CC changes from the DTX/DRX inactive state to the DTX/DRX active state, a new entry corresponding to this CC may be added to the HARQ ACK codebook. On the other hand, if one CC changes the DTX/DRX state from the DTX/DRX active state to the DTX/DRX inactive state, the entry corresponding to the one CC may be removed from the HARQ ACK codebook.

In some aspects, the HARQ ACK codebooks may be dynamically allocated based on the active component carriers. For example, when an SCell or CC is in cell DTX/DRX inactive state, the corresponding codebook entries may be freed up (e.g., released), allowing for a smaller codebook size, or they may be used by another CC for repetition and increased reliability, for example. The HARQ ACK feedback may map to the appropriate codebook entries as the carriers wake up or go to sleep (e.g., in the DTX/DRX active or inactive states).

In some aspects, the adaptation of the HARQ ACK codebook may be based on the RRC-configured pattern or activation/deactivation by a medium access control (MAC)-control element (MAC-CE). In some examples, the configuration for the adaptation of the HARQ ACK codebook may be received via an RRC message. In some examples, the configuration for the adaptation of the HARQ ACK codebook may be received via a MAC-CE. In some examples, the adaptation of the HARQ ACK codebook may be based on Type 1-CB (e.g., semi-static codebook), with the exclusion of physical downlink shared channel (PDSCH) candidates within cell DTX/DRX. In some examples, since the cell DTX/DRX may be semi-statically configured, the adaptation of the codebook size of the Type 1-CB may be semi-statically.

In some aspects, a fallback mechanism may be provided, so that when certain CCs are in sleep mode (e.g., DTX/DRX inactive state), the HARQ ACK codebook may be based on the downlink assignment index (DAI) counter, similar to the HARQ ACK codebook Type 2 (e.g., dynamic HARQ ACK codebook). On the other hands, when all CCs are active (e.g., in the DTX/DRX active state), the semi-static HARQ ACK codebook may be used.

In some aspects, the base station may have additional active time with dynamic indication. For example, the base station may stay active for an additional active time to accommodate for certain user unfinished traffic in the uplink (UL) or downlink (DL), or even to accommodate for random access channel (RACH) procedure. In this case, the codebook may be further adapted to accommodate for the increased active time. The trigger that triggers the additional active time on certain CCs may be the trigger for increasing the size of the codebook. For example, the UE may be informed via DCI that the size of the HARQ ACK has increased or decreased, depending on whether the base station can sleep earlier or not.

In some aspects, the indications for different codebook configurations may be specified together with multi-cell scheduling DCI (MC-DCI). For example, when the MC-DCI is scheduling two CCs, cell 1 and cell 3, one codebook size (e.g., codebook size “A”) may be activated. On the other hand, when the MC-DCI is scheduling three CCs, cell 1, cell 2, and cell 3, then another codebook size (e.g., codebook size “B”) may be activated.

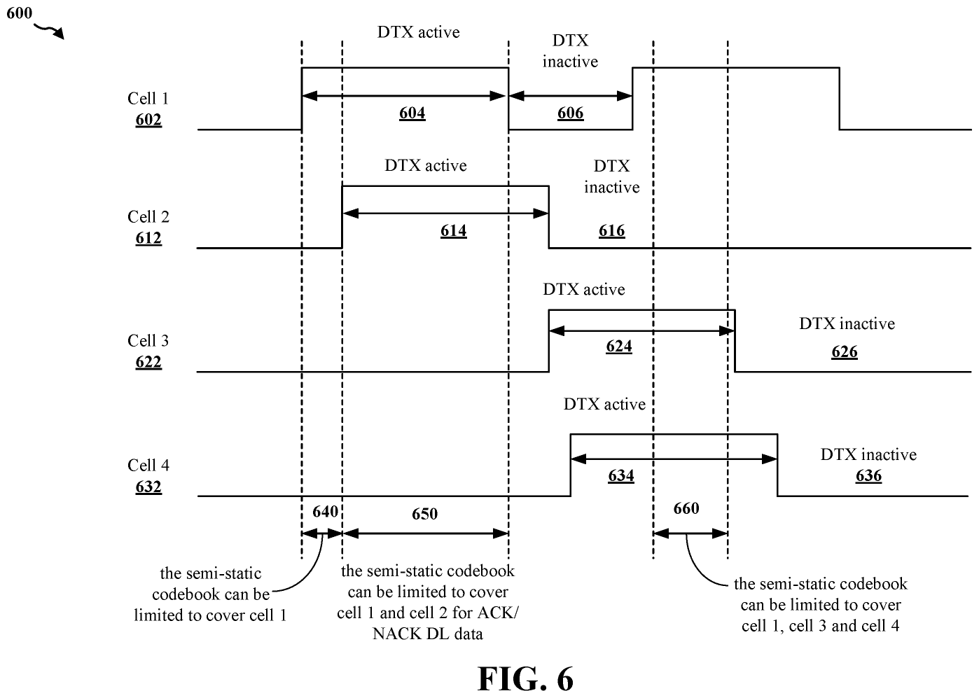

FIG. 6 is a diagram 600 illustrating an example of the adaptation of the semi-static HARQ ACK codebook size in accordance with various aspects of the present disclosure. In FIG. 6, four cells (cell 1 602, cell 2 612, cell 3 622, and cell 4 632) may communicate with a UE. Over a certain period of time, each of the four cells may be in a DTX active state for part of the time and in a DTX inactive state for another part of the time. For example, as shown in FIG. 6, cell 1 602 may be in the DTX active state at 604 and in the DTX inactive state at 606. Similarly, cell 2 612 may be in the DTX active state at 614 and in the DTX inactive state at 616, cell 3 622 may be in the DTX active state at 624 and in the DTX inactive state at 626, and cell 4 632 may be in the DTX active state at 634 and in the DTX inactive state at 636. Depending on each cell's DTX state, the size of the semi-static HARQ ACK codebook may vary. For example, at 640, the semi-static HARQ ACK codebook may be limited to cover cell 1 602 (i.e., the cell that is in the DTX active state at 640), and at 650, the semi-static HARQ ACK codebook may be limited to cover cell 1 602 and cell 2 612 (i.e., the cells that are in the DTX active state at 650). At 660, the HARQ ACK codebook may be limited to cover cell 1 602, cell 3 622, and cell 4 632 (i.e., the cells that are in the DTX active state at 660).

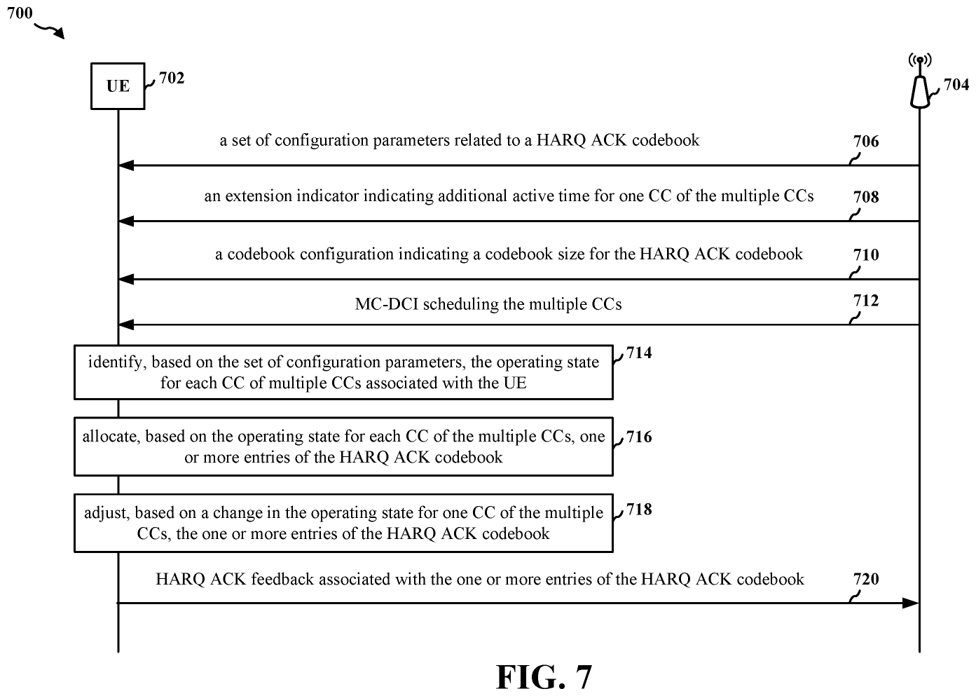

FIG. 7 is a call flow diagram 700 illustrating a method of wireless communication in accordance with various aspects of this present disclosure. Various aspects are described in connection with a UE 702 and a base station 704. The aspects may be performed by the UE 702 or the base station 704 in aggregation and/or by one or more components of a base station 704 (e.g., such as a CU 110, a DU 130, and/or an RU 140).

As shown in FIG. 7, at 706, a UE 702 may receive a set of configuration parameters related to a hybrid automatic repeat request (HARQ) acknowledgement (ACK) codebook from base station 704. For example, the configuration parameters may include information for the implementation of the HARQ ACK codebook.

At 708, the UE 702 may receive an extension indicator from base station 704. The extension indicator may indicate additional active time for one CC of the multiple CCs. For example, the additional active time may accommodate for certain user unfinished traffic in the UL or DL, or accommodate for the RACH procedure.

At 710, the UE 702 may receive, from base station 704, a codebook configuration indicating a codebook size for the HARQ ACK codebook.

At 712, the UE 702 may receive, from base station 704, multi-cell scheduling downlink control information (MC-DCI) scheduling the multiple CCs, and the codebook size may correspond to the multiple CCs. In some examples, the indications for different codebook configurations (at 710) may be specified together with the MC-DCI. For example, when the MC-DCI is scheduling two CCs, cell 1 and cell 3, one codebook configuration (e.g., for codebook size “A”) may be activated. On the other hand, when the MC-DCI is scheduling three CCs, cell 1, cell 2, and cell 3, then another codebook configuration (e.g., for codebook size “B”) may be activated.

At 714, the UE 702 may identify the operating state for each component carrier (CC) of multiple CCs associated with the UE based on the set of configuration parameters (at 706). For example, the operating state may be a DTX/DRX active state or a DTX/DRX inactive state. For example, referring to FIG. 6, the operating state for cell 1 602 may be the DTX active state (at 604) or the DTX inactive state (at 606), and the operating state for cell 2 612 may be the DTX active state (at 614) or the DTX inactive state (at 616).

At 716, the UE 702 may allocate one or more entries of the HARQ ACK codebook based on the operating state for each CC of the multiple CCs. For example, referring to FIG. 6, at 640, the UE may allocate entries of the HARQ ACK codebook to cover cell 1 602 based on the operating state for cell 1 602 (the DTX active state).

At 718, the UE 702 may adjust the one or more entries of the HARQ ACK codebook based on the change in the operating state for one CC of the multiple CCs. For example, referring to FIG. 6, at 650, the UE may add entries of the HARQ ACK codebook to cover cell 2 612 based on the operating state of cell 2 612 is changed from DTX in active state to DTX active state.

At 720, the UE 702 may transmit HARQ ACK feedback associated with the one or more entries of the HARQ ACK codebook to the base station 704.

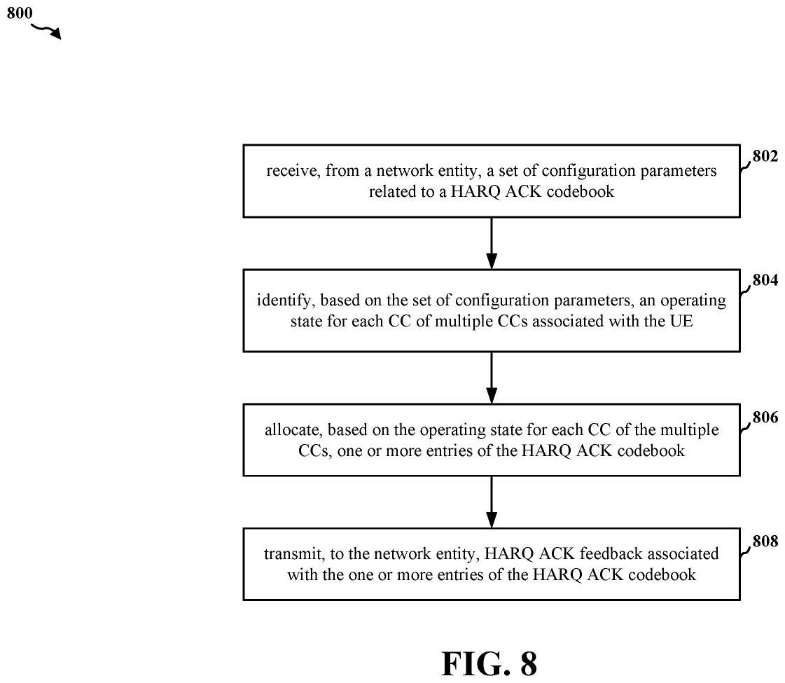

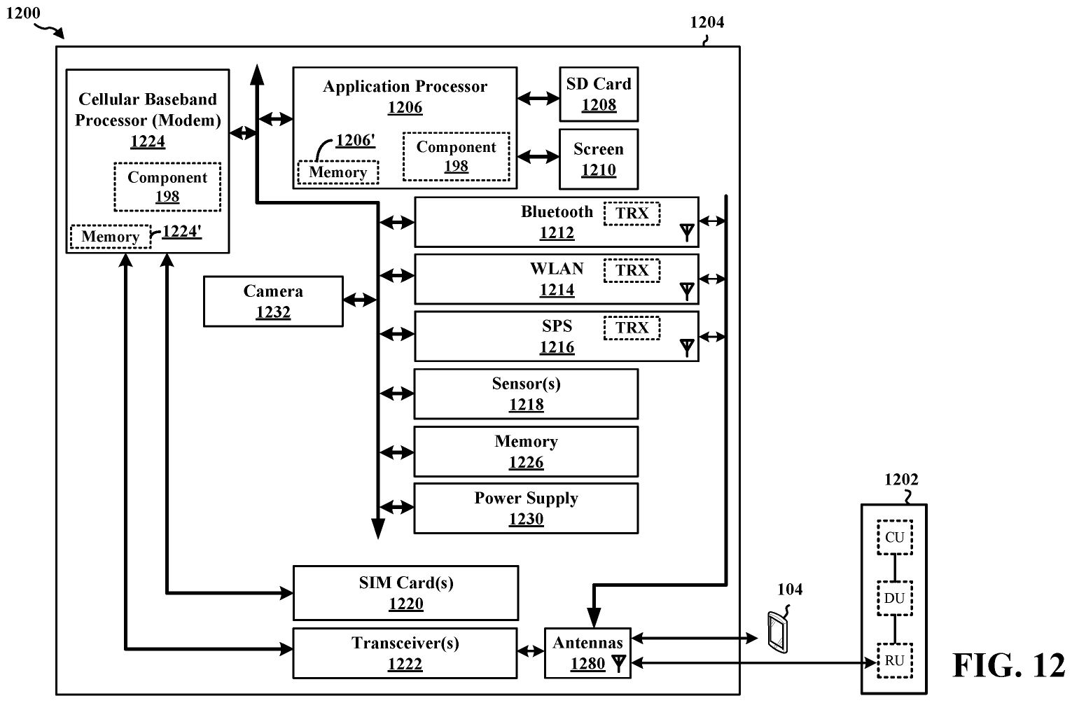

FIG. 8 is a flowchart 800 illustrating methods of wireless communication at a UE in accordance with various aspects of the present disclosure. The method may be performed by a UE. The UE may be the UE 104, 350, 702, or the apparatus 1204 in the hardware implementation of FIG. 12. The methods enable the UE to adapt the HARQ ACK codebooks based on active/inactive operating states of the cells to reduce unnecessary HARQ ACK feedback for inactive cells, thereby reducing signaling overhead and improving accuracy and resource utilization in feedback processes.

As shown in FIG. 8, at 802, the UE may receive a set of configuration parameters related to a HARQ ACK codebook from a network entity. The network entity may be a base station, or a component of a base station, in the access network of FIG. 1 or a core network component (e.g., base station 102, 310, 704; or the network entity 1202 in the hardware implementation of FIG. 12). FIG. 6 and FIG. 7 illustrate various aspects of the steps in connection with flowchart 800. For example, referring to FIG. 7, the UE 702 may receive, at 706, a set of configuration parameters related to a HARQ ACK codebook from a network entity (base station 704). In some aspects, 802 may be performed by the multi-cell feedback component 198.

At 804, the UE may identify the operating state for each CC of multiple CCs associated with the UE based on the set of configuration parameters. For example, referring to FIG. 7, the UE 702 may identify, at 714, the operating state for each CC of multiple CCs associated with the UE based on the set of configuration parameters. Referring to FIG. 6, the operating state for cell 1 602 may be the DTX active state (at 604) or the DTX inactive state (at 606), and the operating state for cell 2 612 may be the DTX active state (at 614) or the DTX inactive state (at 616). In some aspects, 804 may be performed by the multi-cell feedback component 198.

At 806, the UE may allocate one or more entries of the HARQ ACK codebook based on the operating state for each CC of the multiple CCs. For example, referring to FIG. 7, the UE 702 may, at 716, allocate one or more entries of the HARQ ACK codebook based on the operating state for each CC of the multiple CCs. Referring to FIG. 6, at 640, the UE may allocate entries of the HARQ ACK codebook to cover cell 1 602 based on the operating state for cell 1 602 (the DTX active state). In some aspects, 806 may be performed by the multi-cell feedback component 198.

At 808, the UE may transmit HARQ ACK feedback associated with the one or more entries of the HARQ ACK codebook to the network entity. For example, referring to FIG. 7, the UE 702 may transmit, at 720, HARQ ACK feedback associated with the one or more entries of the HARQ ACK codebook to the network entity (base station 704). In some aspects, 808 may be performed by the multi-cell feedback component 198.

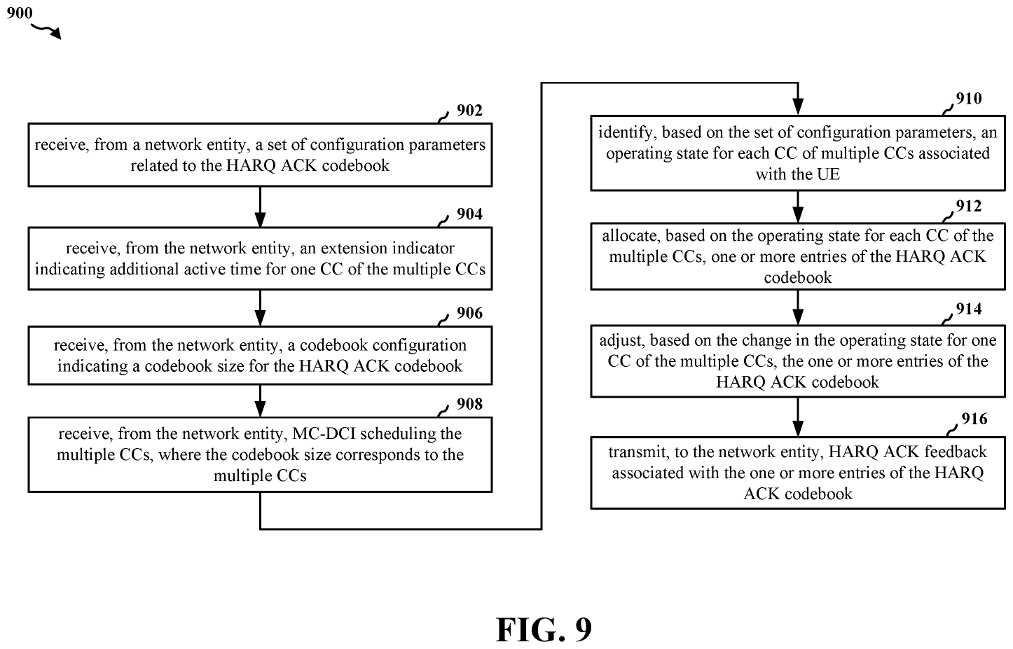

FIG. 9 is a flowchart 900 illustrating methods of wireless communication at a UE in accordance with various aspects of the present disclosure. The method may be performed by a UE. The UE may be the UE 104, 350, 702, or the apparatus 1204 in the hardware implementation of FIG. 12. The methods enable the UE to adapt the HARQ ACK codebooks based on active/inactive operating states of the cells to reduce unnecessary HARQ ACK feedback for inactive cells, thereby reducing signaling overhead and improving accuracy and resource utilization in feedback processes.

As shown in FIG. 9, at 902, the UE may receive a set of configuration parameters related to a HARQ ACK codebook from a network entity. The network entity may be a base station, or a component of a base station, in the access network of FIG. 1 or a core network component (e.g., base station 102, 310, 704; or the network entity 1202 in the hardware implementation of FIG. 12). FIG. 6 and FIG. 7 illustrate various aspects of the steps in connection with flowchart 900. For example, referring to FIG. 7, the UE 702 may receive, at 706, a set of configuration parameters related to a HARQ ACK codebook from a network entity (base station 704). In some aspects, 902 may be performed by the multi-cell feedback component 198.

At 910, the UE may identify the operating state for each CC of multiple CCs associated with the UE based on the set of configuration parameters. For example, referring to FIG. 7, the UE 702 may identify, at 714, the operating state for each CC of multiple CCs associated with the UE based on the set of configuration parameters. Referring to FIG. 6, the operating state for cell 1 602 may be the DTX active state (at 604) or the DTX inactive state (at 606), and the operating state for cell 2 612 may be the DTX active state (at 614) or the DTX inactive state (at 616). In some aspects, 910 may be performed by the multi-cell feedback component 198.

At 912, the UE may allocate one or more entries of the HARQ ACK codebook based on the operating state for each CC of the multiple CCs. For example, referring to FIG. 7, the UE 702 may, at 716, allocate one or more entries of the HARQ ACK codebook based on the operating state for each CC of the multiple CCs. Referring to FIG. 6, at 640, the UE may allocate entries of the HARQ ACK codebook to cover cell 1 602 based on the operating state for cell 1 602 (the DTX active state). In some aspects, 912 may be performed by the multi-cell feedback component 198.

At 916, the UE may transmit HARQ ACK feedback associated with the one or more entries of the HARQ ACK codebook to the network entity. For example, referring to FIG. 7, the UE 702 may transmit, at 720, HARQ ACK feedback associated with the one or more entries of the HARQ ACK codebook to the network entity (base station 704). In some aspects, 916 may be performed by the multi-cell feedback component 198.

In some aspects, the HARQ ACK codebook may be a semi-static HARQ ACK codebook, and the operating state for each CC may be one of a DTX/DRX active state or a DTX/DRX inactive state. For example, referring to FIG. 7, the HARQ ACK codebook (at 706) may be a semi-static HARQ ACK codebook. Referring to FIG. 6, the operating state for cell 1 602 may be an DTX active state (e.g., at 604) or a DTX inactive state (e.g., at 606).

In some aspects, to allocate the one or more entries of the HARQ ACK codebook (at 912), the UE may allocate, in response to the operating state of one CC of the multiple CCs being the DTX/DRX active state, an entry of the HARQ ACK codebook corresponding to the one CC, or release, in response to the operating state of the one CC of the multiple CCs being the DTX/DRX inactive state, the entry of the HARQ ACK codebook corresponding to the one CC. For example, referring to FIG. 6, the UE may allocate an entry of the HARQ ACK codebook corresponding to cell 2 612 (at 614) if the operating state of cell 1 612 is the DTX active state. At 660, the UE may release the entry of the HARQ ACK codebook corresponding to cell 2 612 in response to the operating state of cell 2 612 is the DTX/DRX inactive state.

In some aspects, to receive the set of configuration parameters related to the HARQ ACK codebook (at 902), the UE may receive the set of configuration parameters related to the HARQ ACK codebook via an RRC message. For example, referring to FIG. 7, the UE 702 may receive, at 706, the set of configuration parameters related to the HARQ ACK codebook via an RRC message.

In some aspects, to receive the set of configuration parameters related to the HARQ ACK codebook (at 902), the UE may receive the set of configuration parameters related to the HARQ ACK codebook via a MAC-CE. For example, referring to FIG. 7, the UE 702 may receive, at 706, the set of configuration parameters related to the HARQ ACK codebook via a MAC-CE.

In some aspects, at 914, the UE may adjust the one or more entries of the HARQ ACK codebook based on a change in the operating state for one CC of the multiple CCs. For example, referring to FIG. 7, the UE 702 may, at 718, adjust the one or more entries of the HARQ ACK codebook based on a change in the operating state for one CC of the multiple CCs. In some aspects, 914 may be performed by the multi-cell feedback component 198.

In some aspects, to adjust the one or more entries of the HARQ ACK codebook (at 914), the UE may add an entry corresponding to the one CC to the HARQ ACK codebook in response to the first change in the operating state for the one CC from the DTX/DRX inactive state to the DTX/DRX active state; or remove the entry corresponding to the one CC from the HARQ ACK codebook in response to the second change in the operating state for the one CC from the DTX/DRX active state to the DTX/DRX inactive state. For example, referring to FIG. 6, referring to FIG. 6, at 650, the UE may add entries of the HARQ ACK codebook to cover cell 2 612 based on the operating state of cell 2 612 is changed from DTX in active state to DTX active state. At 660, the UE may remove the entry corresponding to cell 2 612 from the HARQ ACK codebook based on the operating state of cell 2 612 is changed to the DTX inactive state.

In some aspects, to adjust the one or more entries of the HARQ ACK codebook (at 914), the UE may assign the entry corresponding to the one CC to a second CC different from the one CC in response to the second change in the operating state for the one CC from the DTX/DRX active state to the DTX/DRX inactive state. For example, referring to FIG. 6, at 660, the UE may assign the entry corresponding to cell 2 612 to another cell that is different from cell 2 612 in response to the DTX state of cell 2 612 is changed from DTX active state (at 614) to DTX inactive state (at 616).

In some aspects, at 904, the UE may receive an extension indicator indicating additional active time for one CC of the multiple CCs from the network entity. To allocate the one or more entries of the HARQ ACK codebook (at 912), the UE may add the entry corresponding the one CC to the HARQ ACK codebook in response to the extension indicator. For example, referring to FIG. 7, the UE 702 may, at 704, receive an extension indicator indicating additional active time for one CC of the multiple CCs from the network entity. To allocate the one or more entries of the HARQ ACK codebook (at 716), the UE 702 may add the entry corresponding the one CC to the HARQ ACK codebook in response to the extension indicator. In some aspects, 904 may be performed by the multi-cell feedback component 198.

In some aspects, to receive the extension indicator (at 904), the UE may receive the extension indicator via DCI. For example, referring to FIG. 7, the UE 702 may, at 708, receive the extension indicator via DCI.

In some aspects, at 906, the UE may receive a codebook configuration indicating a codebook size for the HARQ ACK codebook from the network entity. To allocate the one or more entries of the HARQ ACK codebook (at 912), the UE may allocate the one or more entries of the HARQ ACK codebook based on the codebook size. For example, referring to FIG. 7, the UE 702 may, at 710, receive a codebook configuration indicating a codebook size for the HARQ ACK codebook from the network entity (base station 704). To allocate the one or more entries of the HARQ ACK codebook (at 716), the UE 702 may allocate the one or more entries of the HARQ ACK codebook based on the codebook size. In some aspects, 906 may be performed by the multi-cell feedback component 198.

In some aspects, at 908, the UE may receive MC-DCI scheduling the multiple CCs from the network entity, and the codebook size may correspond to the multiple CCs. For example, referring to FIG. 7, the UE 702 may, at 712, receive MC-DCI scheduling the multiple CCs from the network entity (base station 704), and the codebook size may correspond to the multiple CCs. In some aspects, 908 may be performed by the multi-cell feedback component 198.

In some aspects, to allocate the one or more entries of the HARQ ACK codebook (at 912), the UE may allocate, based on a first CC in the multiple CCS being in the DTX/DRX inactive state, the one or more entries of the HARQ ACK codebook based on a downlink assignment (DAI) associated with the HARQ ACK codebook. For example, referring to FIG. 7, to allocate the one or more entries of the HARQ ACK codebook (at 716), the UE 702 may allocate, based on a first CC in the multiple CCS being in the DTX/DRX inactive state, the one or more entries of the HARQ ACK codebook based on a downlink assignment (DAI) associated with the HARQ ACK codebook.

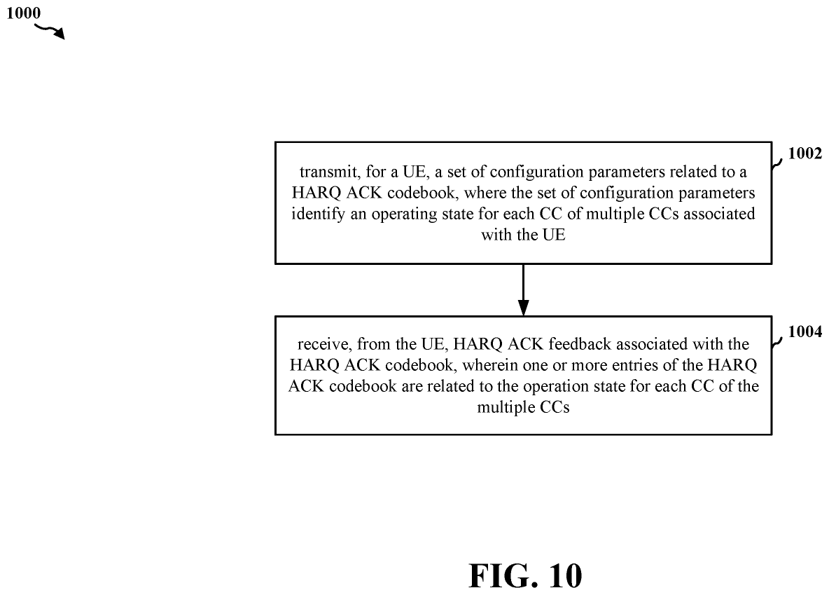

FIG. 10 is a flowchart 1000 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 704; or the network entity 1202 in the hardware implementation of FIG. 12). The methods enable the UE to adapt the HARQ ACK codebooks based on active/inactive operating states of the cells to reduce unnecessary HARQ ACK feedback for inactive cells, thereby reducing signaling overhead and improving accuracy and resource utilization in feedback processes.

As shown in FIG. 10, at 1002, the network entity may transmit, for a UE, a set of configuration parameters related to a HARQ ACK codebook. The set of configuration parameters may identify an operating state for each CC of multiple CCs associated with the UE. The UE may be the UE 104, 350, 702, or the apparatus 1204 in the hardware implementation of FIG. 12. FIG. 6 and FIG. 7 illustrate various aspects of the steps in connection with flowchart 1000. For example, referring to FIG. 7, the network entity (base station 704) may transmit, at 706, for a UE 702, a set of configuration parameters related to a HARQ ACK codebook. In some aspects, 1002 may be performed by the multi-cell feedback component 199.

At 1004, the network entity may receive, from the UE, HARQ ACK feedback associated with the HARQ ACK codebook. One or more entries of the HARQ ACK codebook may be related to the operation state for each CC of the multiple CCs. For example, referring to FIG. 7, the network entity (base station 704) may receive, at 720, from the UE 702, HARQ ACK feedback associated with the HARQ ACK codebook. One or more entries of the HARQ ACK codebook may be related to the operation state for each CC of the multiple CCs. In some aspects, 1004 may be performed by the multi-cell feedback component 199.

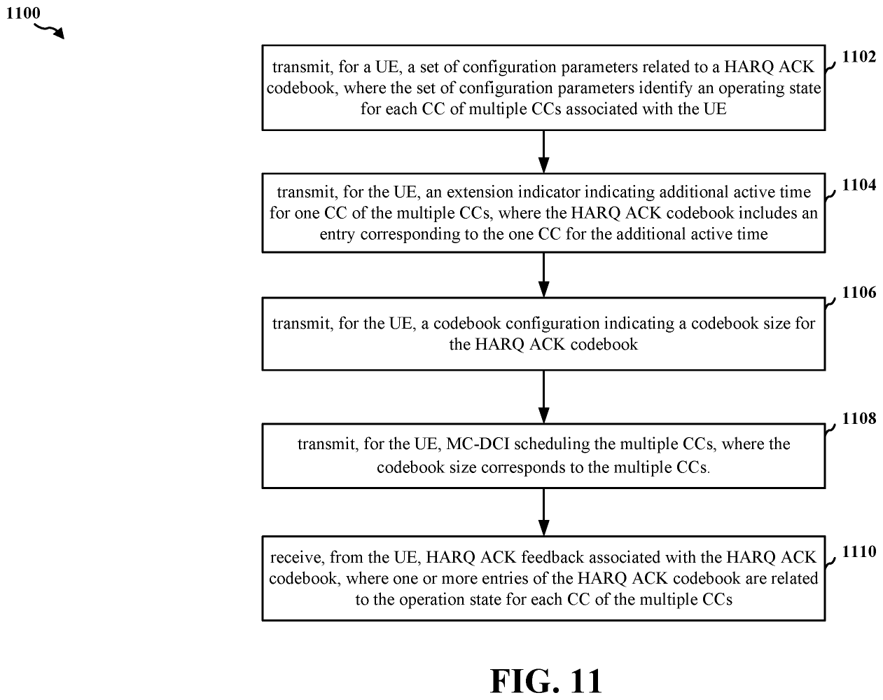

FIG. 11 is a flowchart 1100 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 704; or the network entity 1202 in the hardware implementation of FIG. 12). The methods enable the UE to adapt the HARQ ACK codebooks based on active/inactive operating states of the cells to reduce unnecessary HARQ ACK feedback for inactive cells, thereby reducing signaling overhead and improving accuracy and resource utilization in feedback processes.

As shown in FIG. 11, at 1102, the network entity may transmit, for a UE, a set of configuration parameters related to a HARQ ACK codebook. The set of configuration parameters may identify an operating state for each CC of multiple CCs associated with the UE. The UE may be the UE 104, 350, 702, or the apparatus 1204 in the hardware implementation of FIG. 12. FIG. 6 and FIG. 7 illustrate various aspects of the steps in connection with flowchart 1100. For example, referring to FIG. 7, the network entity (base station 704) may transmit, at 706, for a UE 702, a set of configuration parameters related to a HARQ ACK codebook. In some aspects, 1102 may be performed by the multi-cell feedback component 199.

At 1110, the network entity may receive, from the UE, HARQ ACK feedback associated with the HARQ ACK codebook. One or more entries of the HARQ ACK codebook may be related to the operation state for each CC of the multiple CCs. For example, referring to FIG. 7, the network entity (base station 704) may receive, at 720, from the UE 702, HARQ ACK feedback associated with the HARQ ACK codebook. One or more entries of the HARQ ACK codebook may be related to the operation state for each CC of the multiple CCs. In some aspects, 1110 may be performed by the multi-cell feedback component 199.

In some aspects, the HARQ ACK codebook is may be semi-static HARQ ACK codebook, and the operating state for each CC may be one of the DTX/DRX active state or the DTX/DRX inactive state. For example, referring to FIG. 7, the HARQ ACK codebook (at 706) may be a semi-static HARQ ACK codebook. Referring to FIG. 6, the operating state for cell 1 602 may be an DTX active state (e.g., at 604) or a DTX inactive state (e.g., at 606).

In some aspects, the one or more entries of the HARQ ACK codebook is the number of CCs in the multiple CCs that are in the DTX/DRX active state. For example, referring to FIG. 6, at 650, the entries of the HARQ ACK codebook may be limited to cover cell 1 602 and cell 2 612, which are in the DTX active state.

In some aspects, to transmit the set of configuration parameters related to the HARQ ACK codebook (at 1102), the network entity may transmit the set of configuration parameters related to the HARQ ACK codebook via an RRC message. For example, referring to FIG. 7, the network entity (base station 704) may transmit, at 706, the set of configuration parameters related to the HARQ ACK codebook via an RRC message.

In some aspects, to transmit the set of configuration parameters related to the HARQ ACK codebook (at 1102), the network entity may transmit the set of configuration parameters related to the HARQ ACK codebook via a MAC-CE. For example, referring to FIG. 7, the network entity (base station 704) may transmit, at 706, the set of configuration parameters related to the HARQ ACK codebook via a MAC-CE.

In some aspects, at 1104, the network entity may transmit, for the UE, an extension indicator indicating additional active time for one CC of the multiple CCs, and the HARQ ACK codebook may include an entry corresponding to the one CC for the additional active time. For example, referring to FIG. 7, the network entity (base station 704) may transmit, at 708, for the UE 702, an extension indicator indicating additional active time for one CC of the multiple CCs, and the HARQ ACK codebook may include an entry corresponding to the one CC for the additional active time. In some aspects, 1104 may be performed by the multi-cell feedback component 199.

In some aspects, to transmit the extension indicator (at 1104), the network entity may transmit the extension indicator via DCI. For example, referring to FIG. 7, the network entity (base station 704) may transmit, at 708, the extension indicator via DCI.

In some aspects, at 1106, the network entity may transmit, for the UE, a codebook configuration indicating a codebook size for the HARQ ACK codebook. To receive the HARQ ACK feedback (at 1110), the network entity may receive the HARQ ACK feedback associated with the HARQ ACK codebook having the codebook size. For example, referring to FIG. 7, the network entity (base station 704) may transmit, at 710, for the UE 702, a codebook configuration indicating a codebook size for the HARQ ACK codebook. The network entity (base station 704) may receive, at 720, the HARQ ACK feedback associated with the HARQ ACK codebook having the codebook size. In some aspects, 1106 may be performed by the multi-cell feedback component 199.

In some aspects, at 1108, the network entity may transmit, for the UE, MC-DCI scheduling the multiple CCs, and the codebook size may correspond to the multiple CCs. For example, referring to FIG. 7, the network entity (base station 704) may transmit, at 712, for the UE 702, MC-DCI scheduling the multiple CCs, and the codebook size may correspond to the multiple CCs. In some aspects, 1108 may be performed by the multi-cell feedback component 199.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor (or processing circuitry) 1224 (also referred to as a modem) coupled to one or more transceivers 1222 (e.g., cellular RF transceiver). The cellular baseband processor(s) (or processing circuitry) 1224 may include at least one on-chip memory (or memory circuitry) 1224′. In some aspects, the apparatus 1204 may further include one or more subscriber identity modules (SIM) cards 1220 and at least one application processor (or processing circuitry) 1206 coupled to a secure digital (SD) card 1208 and a screen 1210. The application processor(s) (or processing circuitry) 1206 may include on-chip memory (or memory circuitry) 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) (or processing circuitry) 1224 communicates through the transceiver(s) 1222 via one or more antennas 1280 with the UE 104 and/or with an RU associated with a network entity 1202. The cellular baseband processor(s) (or processing circuitry) 1224 and the application processor(s) (or processing circuitry) 1206 may each include a computer-readable medium/memory (or memory circuitry) 1224′, 1206′, respectively. The additional memory modules 1226 may also be considered a computer-readable medium/memory (or memory circuitry). Each computer-readable medium/memory (or memory circuitry) 1224′, 1206′, 1226 may be non-transitory. The cellular baseband processor(s) (or processing circuitry) 1224 and the application processor(s) (or processing circuitry) 1206 are each responsible for general processing, including the execution of software stored on the computer-readable medium/memory (or memory circuitry). The software, when executed by the cellular baseband processor(s) (or processing circuitry) 1224/application processor(s) (or processing circuitry) 1206, causes the cellular baseband processor(s) (or processing circuitry) 1224/application processor(s) (or processing circuitry) 1206 to perform the various functions described supra. The cellular baseband processor(s) (or processing circuitry) 1224 and the application processor(s) (or processing circuitry) 1206 are configured to perform the various functions described supra based at least in part of the information stored in the memory (or memory circuitry). That is, the cellular baseband processor(s) (or processing circuitry) 1224 and the application processor(s) (or processing circuitry) 1206 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1224/application processor(s) (or processing circuitry) 1206 when executing software. The cellular baseband processor(s) (or processing circuitry) 1224/application processor(s) (or processing circuitry) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) (or processing circuitry) 1224 and/or the application processor(s) (or processing circuitry) 1206, and in another configuration, the apparatus 1204 may be the entire UE (e.g., see UE 350 of FIG. 3) and include the additional modules of the apparatus 1204.

As discussed supra, the component 198 may be configured to receive, from a network entity, a set of configuration parameters related to a HARQ ACK codebook; identify, based on the set of configuration parameters, an operating state for each CC of multiple CCs associated with the UE; allocate, based on the operating state for each CC of the multiple CCs, one or more entries of the HARQ ACK codebook; and transmit, to the network entity, HARQ ACK feedback associated with the one or more entries of the HARQ ACK codebook. The component 198 may be further configured to perform any of the aspects described in connection with the flowcharts in FIG. 8 and FIG. 9, and/or performed by the UE 702 in FIG. 7. The component 198 may be within the cellular baseband processor(s) (or processing circuitry) 1224, the application processor(s) (or processing circuitry) 1206, or both the cellular baseband processor(s) (or processing circuitry) 1224 and the application processor(s) (or processing circuitry) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) (or processing circuitry) 1224 and/or the application processor(s) (or processing circuitry) 1206, includes means for receiving, from a network entity, a set of configuration parameters related to a HARQ ACK codebook, means for identifying, based on the set of configuration parameters, an operating state for each CC of multiple CCs associated with the UE, means for allocating, based on the operating state for each CC of the multiple CCs, one or more entries of the HARQ ACK codebook, and means for transmitting, to the network entity, HARQ ACK feedback associated with the one or more entries of the HARQ ACK codebook. The apparatus 1204 may further include means for performing any of the aspects described in connection with the flowcharts in FIG. 8 and FIG. 9, and/or aspects performed by the UE 702 in FIG. 7. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

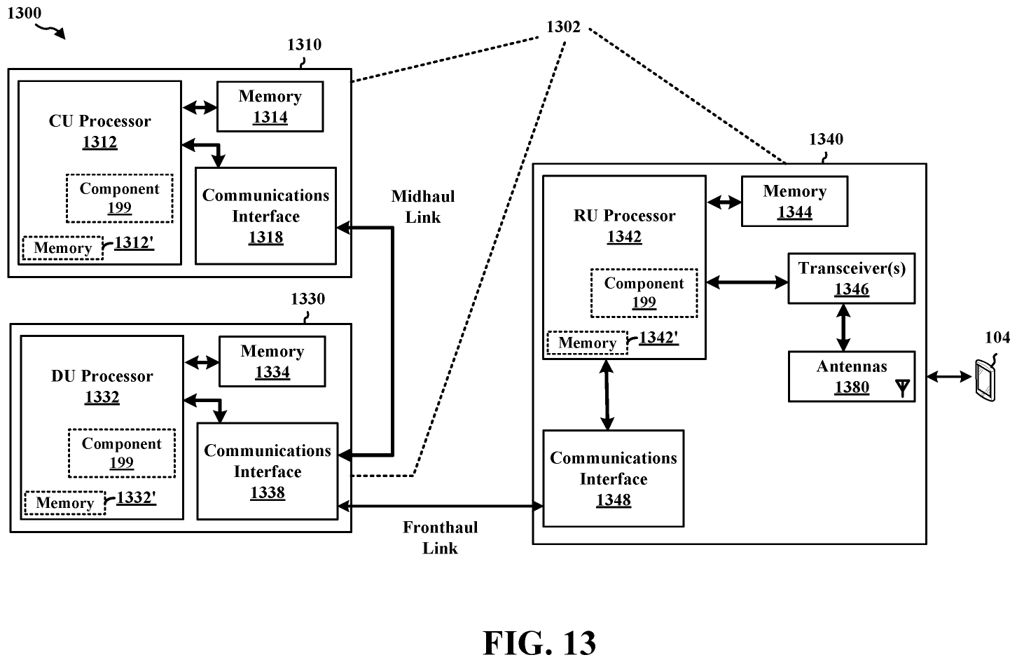

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor (or processing circuitry) 1312. The CU processor(s) (or processing circuitry) 1312 may include on-chip memory (or memory circuitry) 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor (or processing circuitry) 1332. The DU processor(s) (or processing circuitry) 1332 may include on-chip memory (or memory circuitry) 1332′. In some aspects, the DU 1330 may further include additional memory modules 1334 and a communications interface 1338. The DU 1330 communicates with the RU 1340 through a fronthaul link. The RU 1340 may include at least one RU processor (or processing circuitry) 1342. The RU processor(s) (or processing circuitry) 1342 may include on-chip memory (or memory circuitry) 1342′. In some aspects, the RU 1340 may further include additional memory modules 1344, one or more transceivers 1346, antennas 1380, and a communications interface 1348. The RU 1340 communicates with the UE 104. The on-chip memory (or memory circuitry) 1312′, 1332′, 1342′ and the additional memory modules 1314, 1334, 1344 may each be considered a computer-readable medium/memory (or memory circuitry). Each computer-readable medium/memory (or memory circuitry) may be non-transitory. Each of the processors (or processing circuitry) 1312, 1332, 1342 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit, for a UE, a set of configuration parameters related to a HARQ ACK codebook, where the set of configuration parameters identify an operating state for each CC of multiple CCs associated with the UE; and receive, from the UE, HARQ ACK feedback associated with the HARQ ACK codebook, where one or more entries of the HARQ ACK codebook are related to the operation state for each CC of the multiple CCs. The component 199 may be further configured to perform any of the aspects described in connection with the flowcharts in FIG. 10 and FIG. 11, and/or performed by the base station 704 in FIG. 7. The component 199 may be within one or more processors (or processing circuitry) of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 includes means for transmitting, for a UE, a set of configuration parameters related to a HARQ ACK codebook, where the set of configuration parameters identify an operating state for each CC of multiple CCs associated with the UE, and means for receiving, from the UE, HARQ ACK feedback associated with the HARQ ACK codebook, where one or more entries of the HARQ ACK codebook are related to the operation state for each CC of the multiple CCs. The network entity 1302 may further include means for performing any of the aspects described in connection with the flowcharts in FIG. 10 and FIG. 11, and/or aspects performed by the base station 704 in FIG. 7. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a network entity, a set of configuration parameters related to a HARQ ACK codebook; identifying, based on the set of configuration parameters, an operating state for each CC of multiple CCs associated with the UE; allocating, based on the operating state for each CC of the multiple CCs, one or more entries of the HARQ ACK codebook; and transmitting, to the network entity, HARQ ACK feedback associated with the one or more entries of the HARQ ACK codebook. The methods enable the UE to adapt the HARQ ACK codebooks based on active/inactive operating states of the cells to reduce unnecessary HARQ ACK feedback for inactive cells, thereby reducing signaling overhead and improving accuracy and resource utilization in feedback processes.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method may include receiving, from a network entity, a set of configuration parameters related to a hybrid automatic repeat request (HARQ) acknowledgement (ACK) codebook; identifying, based on the set of configuration parameters, an operating state for each component carrier (CC) of multiple CCs associated with the UE; allocating, based on the operating state for each CC of the multiple CCs, one or more entries of the HARQ ACK codebook; and transmitting, to the network entity, HARQ ACK feedback associated with the one or more entries of the HARQ ACK codebook.

Aspect 2 is the method of aspect 1, wherein the HARQ ACK codebook may be a semi-static HARQ ACK codebook, and wherein the operating state for each CC may be one of a discontinuous transmission (DTX)/discontinuous reception (DRX) active state or a DTX/DRX inactive state.

Aspect 3 is the method of any of aspects 1 to 2, wherein allocating the one or more entries of the HARQ ACK codebook may include: allocating, in response to the operating state of one CC of the multiple CCs being the DTX/DRX active state, an entry of the HARQ ACK codebook corresponding to the one CC; or releasing, in response to the operating state of the one CC of the multiple CCs being the DTX/DRX inactive state, the entry of the HARQ ACK codebook corresponding to the one CC.

Aspect 4 is the method of any of aspects 1 to 3, wherein receiving the set of configuration parameters related to the HARQ ACK codebook may include: receiving, via a radio resource configuration (RRC) message, the set of configuration parameters related to the HARQ ACK codebook.

Aspect 5 is the method of any of aspects 1 to 3, wherein receiving the set of configuration parameters related to the HARQ ACK codebook may include: receiving, via a medium access control (MAC)-control element (MAC-CE), the set of configuration parameters related to the HARQ ACK codebook.

Aspect 6 is the method of any of aspects 1 to 5, where the method may further include adjusting, based on the change in the operating state for one CC of the multiple CCs, the one or more entries of the HARQ ACK codebook.

Aspect 7 is the method of aspect 6, wherein adjusting the one or more entries of the HARQ ACK codebook may include: adding, in response to a first change in the operating state for the one CC from the DTX/DRX inactive state to the DTX/DRX active state, an entry corresponding to the one CC to the HARQ ACK codebook; or removing, in response to a second change in the operating state for the one CC from the DTX/DRX active state to the DTX/DRX inactive state, the entry corresponding to the one CC from the HARQ ACK codebook.

Aspect 8 is the method of aspect 6, wherein adjusting the one or more entries of the HARQ ACK codebook may include assigning, in response to a second change in the operating state for the one CC from the DTX/DRX active state to the DTX/DRX inactive state, the entry corresponding to the one CC to a second CC different from the one CC.

Aspect 9 is the method of any of aspects 1 to 8, where the method may further include receiving, from the network entity, an extension indicator indicating additional active time for one CC of the multiple CCs, and wherein allocating the one or more entries of the HARQ ACK codebook may include adding the entry corresponding the one CC to the HARQ ACK codebook in response to the extension indicator.

Aspect 10 is the method of aspect 9, wherein receiving the extension indicator may include receiving the extension indicator via downlink control information (DCI).

Aspect 11 is the method of any of aspects 1 to 10, where the method may further include receiving, from the network entity, a codebook configuration indicating a codebook size for the HARQ ACK codebook, and wherein allocating the one or more entries of the HARQ ACK codebook may include allocating the one or more entries of the HARQ ACK codebook based on the codebook size.

Aspect 12 is the method of aspect 11, where the method may further include receiving, from the network entity, multi-cell scheduling downlink control information (MC-DCI) scheduling the multiple CCs, and wherein the codebook size may correspond to the multiple CCs.

Aspect 13 is the method of any of aspects 1 to 12, wherein allocating the one or more entries of the HARQ ACK codebook may include allocating, based on a first CC in the multiple CCS being in a discontinuous transmission (DTX)/discontinuous reception (DRX) inactive state, the one or more entries of the HARQ ACK codebook based on a downlink assignment (DAI) associated with the HARQ ACK codebook.

Aspect 14 is an apparatus for wireless communication at a UE, comprising: a processing system that includes processor circuitry and memory circuitry that stores code and is coupled with the processor circuitry, the processing system configured to cause the UE to perform the method of one or more of Aspects 1-13.

Aspect 15 is an apparatus for wireless communication at a UE, comprising: at least one memory; and at least one processor coupled to the at least one memory and, based at least in part on information stored in the at least one memory, the at least one processor, individually or in any combination, is configured to perform the method of any of aspects 1-13.

Aspect 16 is the apparatus for wireless communication at a UE, comprising means for performing each step in the method of any of aspects 1-13.

Aspect 17 is an apparatus of any of aspects 14-16, further comprising a transceiver configured to receive or to transmit in association with the method of any of aspects 1-13.

Aspect 18 is a computer-readable medium (e.g., a non-transitory computer-readable medium) storing computer executable code at a UE, the code when executed by at least one processor causes the at least one processor to, individually or in any combination, perform the method of any of aspects 1-13.

Aspect 19 is a method of wireless communication at a network entity. The method may include transmitting, for a user equipment (UE), a set of configuration parameters related to a hybrid automatic repeat request (HARQ) acknowledgement (ACK) codebook, wherein the set of configuration parameters identify an operating state for each component carrier (CC) of multiple CCs associated with the UE; and receiving, from the UE, HARQ ACK feedback associated with the HARQ ACK codebook, wherein one or more entries of the HARQ ACK codebook are related to the operation state for each CC of the multiple CCs.

Aspect 20 is the method of aspect 19, wherein the HARQ ACK codebook may be a semi-static HARQ ACK codebook, and wherein the operating state for each CC may be one of a discontinuous transmission (DTX)/discontinuous reception (DRX) active state or a DTX/DRX inactive state.

Aspect 21 is the method of any of aspects 19 to 20, wherein the one or more entries of the HARQ ACK codebook is a number of CCs in the multiple CCs that are in the DTX/DRX active state

Aspect 22 is the method of any of aspects 19 to 21, wherein transmitting the set of configuration parameters related to the HARQ ACK codebook may include transmitting, via a radio resource configuration (RRC) message, the set of configuration parameters related to the HARQ ACK codebook.

Aspect 23 is the method of any of aspects 19 to 21, wherein transmitting the set of configuration parameters related to the HARQ ACK codebook may include transmitting, via a medium access control (MAC)-control element (MAC-CE), the set of configuration parameters related to the HARQ ACK codebook.

Aspect 24 is the method of any of aspects 19 to 23, where the method may further include transmitting, for the UE, an extension indicator indicating additional active time for one CC of the multiple CCs, and wherein the HARQ ACK codebook includes an entry corresponding to the one CC for the additional active time.

Aspect 25 is the method of aspect 24, wherein transmitting the extension indicator may include transmitting the extension indicator via downlink control information (DCI).

Aspect 26 is the method of any of aspects 19 to 25, where the method may further include transmitting, for the UE, a codebook configuration indicating a codebook size for the HARQ ACK codebook, and wherein receiving the HARQ ACK feedback may include receiving the HARQ ACK feedback associated with the HARQ ACK codebook having the codebook size.

Aspect 27 is the method of any of aspects 19 to 26, where the method may further include transmitting, for the UE, multi-cell scheduling downlink control information (MC-DCI) scheduling the multiple CCs, and wherein the codebook size corresponds the multiple CCs.

Aspect 28 is an apparatus for wireless communication at a network entity, comprising: a processing system that includes processor circuitry and memory circuitry that stores code and is coupled with the processor circuitry, the processing system configured to cause the network entity to perform the method of one or more of aspects 19-27.

Aspect 29 is an apparatus for wireless communication at a network entity, comprising: at least one memory; and at least one processor coupled to the at least one memory and, based at least in part on information stored in the at least one memory, the at least one processor, individually or in any combination, is configured to perform the method of any of aspects 19-27.

Aspect 30 is the apparatus for wireless communication at a network entity, comprising means for performing each step in the method of any of aspects 19-27.

Aspect 31 is an apparatus of any of aspects 28-30, further comprising a transceiver configured to receive or to transmit in association with the method of any of aspects 19-27.

Aspect 32 is a computer-readable medium (e.g., a non-transitory computer-readable medium) storing computer executable code at a network entity, the code when executed by at least one processor causes the at least one processor to, individually or in any combination, perform the method of any of aspects 19-27.

What is claimed is:

1. An apparatus of wireless communication at a user equipment (UE), comprising:
at least one memory; and
at least one processor coupled to the at least one memory and, based at least in part on information stored in the at least one memory, the at least one processor, individually or in any combination, is configured to:
receive, from a network entity, a set of configuration parameters related to a hybrid automatic repeat request (HARQ) acknowledgement (ACK) codebook;
identify, based on the set of configuration parameters, an operating state for each component carrier (CC) of multiple CCs associated with the UE;
allocate, based on the operating state for each CC of the multiple CCs, one or more entries of the HARQ ACK codebook; and
transmit, to the network entity, HARQ ACK feedback associated with the one or more entries of the HARQ ACK codebook.

2. The apparatus of claim 1, further comprising a transceiver coupled to the at least one processor, wherein, to receive the set of configuration parameters related to the HARQ ACK codebook, the at least one processor, individually or in any combination, is configured to receive the set of configuration parameters related to the HARQ ACK codebook via the transceiver, wherein the HARQ ACK codebook is a semi-static HARQ ACK codebook, and wherein the operating state for each CC is one of a discontinuous transmission (DTX)/discontinuous reception (DRX) active state or a DTX/DRX inactive state.

3. The apparatus of claim 2, wherein to allocate the one or more entries of the HARQ ACK codebook, the at least one processor, individually or in any combination, is configured to:
allocate, in response to the operating state of one CC of the multiple CCs being the DTX/DRX active state, an entry of the HARQ ACK codebook corresponding to the one CC; or
release, in response to the operating state of the one CC of the multiple CCs being the DTX/DRX inactive state, the entry of the HARQ ACK codebook corresponding to the one CC.

4. The apparatus of claim 2, wherein to receive the set of configuration parameters related to the HARQ ACK codebook, the at least one processor, individually or in any combination, is configured to:
receive, via a radio resource configuration (RRC) message, the set of configuration parameters related to the HARQ ACK codebook.

5. The apparatus of claim 2, wherein to receive the set of configuration parameters related to the HARQ ACK codebook, the at least one processor, individually or in any combination, is configured to:
receive, via a medium access control (MAC)-control element (MAC-CE), the set of configuration parameters related to the HARQ ACK codebook.

6. The apparatus of claim 2, wherein the at least one processor, individually or in any combination, is further configured to:
adjust, based on a change in the operating state for one CC of the multiple CCs, the one or more entries of the HARQ ACK codebook.

7. The apparatus of claim 6, wherein to adjust the one or more entries of the HARQ ACK codebook, the at least one processor, individually or in any combination, is configured to:
add, in response to a first change in the operating state for the one CC from the DTX/DRX inactive state to the DTX/DRX active state, an entry corresponding to the one CC to the HARQ ACK codebook; or
remove, in response to a second change in the operating state for the one CC from the DTX/DRX active state to the DTX/DRX inactive state, the entry corresponding to the one CC from the HARQ ACK codebook.

8. The apparatus of claim 6, wherein to adjust the one or more entries of the HARQ ACK codebook, the at least one processor, individually or in any combination, is configured to:
assign, in response to a second change in the operating state for the one CC from the DTX/DRX active state to the DTX/DRX inactive state, the entry corresponding to the one CC to a second CC different from the one CC.

9. The apparatus of claim 2, wherein the at least one processor, individually or in any combination, is further configured to:
receive, from the network entity, an extension indicator indicating additional active time for one CC of the multiple CCs, and wherein to allocate the one or more entries of the HARQ ACK codebook, the at least one processor, individually or in any combination, is configured to:
add the entry corresponding the one CC to the HARQ ACK codebook in response to the extension indicator.

10. The apparatus of claim 9, wherein to receive the extension indicator, the at least one processor, individually or in any combination, is configured to:
receive the extension indicator via downlink control information (DCI).

11. The apparatus of claim 2, wherein the at least one processor, individually or in any combination, is further configured to:
receive, from the network entity, a codebook configuration indicating a codebook size for the HARQ ACK codebook, and wherein to allocate the one or more entries of the HARQ ACK codebook, the at least one processor, individually or in any combination, is configured to:
allocate the one or more entries of the HARQ ACK codebook based on the codebook size.

12. The apparatus of claim 11, wherein the at least one processor, individually or in any combination, is configured to:
receive, from the network entity, multi-cell scheduling downlink control information (MC-DCI) scheduling the multiple CCs, and wherein the codebook size corresponds to the multiple CCs.

13. The apparatus of claim 1, wherein to allocate the one or more entries of the HARQ ACK codebook, the at least one processor, individually or in any combination, is configured to:
allocate, based on a first CC in the multiple CCS being in a discontinuous transmission (DTX)/discontinuous reception (DRX) inactive state, the one or more entries of the HARQ ACK codebook based on a downlink assignment (DAI) associated with the HARQ ACK codebook.

14. An apparatus of wireless communication at a network entity, comprising:
at least one memory; and
at least one processor coupled to the at least one memory and, based at least in part on information stored in the at least one memory, the at least one processor, individually or in any combination, is configured to:
transmit, for a user equipment (UE), a set of configuration parameters related to a hybrid automatic repeat request (HARQ) acknowledgement (ACK) codebook, wherein the set of configuration parameters identify an operating state for each component carrier (CC) of multiple CCs associated with the UE; and
receive, from the UE, HARQ ACK feedback associated with the HARQ ACK codebook, wherein one or more entries of the HARQ ACK codebook are related to the operation state for each CC of the multiple CCs.

15. The apparatus of claim 14, further comprising a transceiver coupled to the at least one processor, wherein, to transmit the set of configuration parameters related to the HARQ ACK codebook, the at least one processor, individually or in any combination, is configured to transmit the set of configuration parameters related to the HARQ ACK codebook via the transceiver, wherein the HARQ ACK codebook is a semi-static HARQ ACK codebook, and wherein the operating state for each CC is one of a discontinuous transmission (DTX)/discontinuous reception (DRX) active state or a DTX/DRX inactive state.

16. The apparatus of claim 15, wherein the one or more entries of the HARQ ACK codebook is a number of CCs in the multiple CCs that are in the DTX/DRX active state.

17. The apparatus of claim 15, wherein to transmit the set of configuration parameters related to the HARQ ACK codebook, the at least one processor, individually or in any combination, is configured to:
transmit, via a radio resource configuration (RRC) message, the set of configuration parameters related to the HARQ ACK codebook.

18. The apparatus of claim 15, wherein to transmit the set of configuration parameters related to the HARQ ACK codebook, the at least one processor, individually or in any combination, is configured to:
transmit, via a medium access control (MAC)-control element (MAC-CE), the set of configuration parameters related to the HARQ ACK codebook.

19. The apparatus of claim 15, wherein the at least one processor, individually or in any combination, is further configured to:
transmit, for the UE, an extension indicator indicating additional active time for one CC of the multiple CCs, and wherein the HARQ ACK codebook includes an entry corresponding to the one CC for the additional active time.

20. A method of wireless communication at a user equipment (UE), comprising:
receiving, from a network entity, a set of configuration parameters related to a hybrid automatic repeat request (HARQ) acknowledgement (ACK) codebook;
identifying, based on the set of configuration parameters, an operating state for each component carrier (CC) of multiple CCs associated with the UE;
allocating, based on the operating state for each CC of the multiple CCs, one or more entries of the HARQ ACK codebook; and
transmitting, to the network entity, HARQ ACK feedback associated with the one or more entries of the HARQ ACK codebook.
